(19) United States
(12) Patent Application Publication
(10) Pub. No.: US 2009/0300208 A1
(43) Pub. Date: Dec. 3, 2009

(54) METHODS AND SYSTEMS FOR ACCELERATION OF MESH NETWORK CONFIGURATIONS

(75) Inventor: Peter Lepeska, Boston, MA (US)

Correspondence Address: TOWNSEND AND TOWNSEND AND CREW LLP;VIASAT, INC. (CLIENT #017018), TWO EMBARCADERO CENTER, 8TH FLOOR, SAN FRANCISCO, CA, 94111, US

(73) Assignee: ViaSat, Inc., Carlsbad, CA (US)

(21) Appl. No.: 12/476,340

(22) Filed: Jun. 2, 2009

Related U.S. Application Data
(60) Provisional application No. 61/058,011, filed on Jun. 2, 2008.

(51) Int. Cl. G06F 15/173

(52) U.S. Cl. 709/233

(57) ABSTRACT

The present invention relates to systems, apparatus, and methods of accelerating network traffic within a mesh network. The method includes receiving a data request from a client system, determining a first set of latency values between each of a plurality of acceleration servers and the client system, and determining a second set of latency values between each of a plurality of content servers and each of the plurality of acceleration servers. The method further includes based on the first and second sets of latency values, selecting an acceleration server and content server combination with the lowest latency, creating an acceleration tunnel between the client system and the selected content server through the selected acceleration server, and transmitting the data to the client system using the created acceleration tunnel.

### PRIORITY CLAIM

This application claims priority to U.S. Provisional Application No. 61/058,011, entitled METHODS AND SYSTEMS FOR ACCELERATION OF MESH NETWORK CONFIGURATIONS, filed on Jun. 2, 2008, which is incorporated by reference in its entirety for any and all purposes.

### FIELD OF THE INVENTION

The present invention relates, in general, to network acceleration and, more particularly, to acceleration of mesh networks.

### BACKGROUND

Presently, in mesh (and other) network configurations the content is not necessarily delivered from a content source most suited to delivery the content at the faster rate (e.g., the source with the lowest latency, the highest bandwidth capacity, etc.). Thus, where content could be delivery at a much faster rate, current network configurations fail to fully take advantage of faster content delivery options. Thus, improvements in the art are needed.

### BRIEF SUMMARY

Embodiments of the present invention are directed to a method of accelerating network traffic within a mesh network. The method includes receiving a data request from a client system, determining a first set of latency values between each of a plurality of acceleration servers and the client system, and determining a second set of latency values between each of a plurality of content servers and each of the plurality of acceleration servers. The method further includes based on the first and second sets of latency values, selecting an acceleration server and content server combination with the lowest latency, creating an acceleration tunnel between the client system and the selected content server through the selected acceleration server, and transmitting the data to the client system using the created acceleration tunnel.

A further embodiments is directed to a method of accelerating network traffic within a mesh network. The method includes receiving, at an acceleration server from a client system, a request for data, determining which of a plurality of content servers the data is stored, wherein the acceleration server, the client system, and the plurality of content servers are configured in a mesh network, and determining latency between the acceleration server and the plurality of content servers in which the data is stored. The method further includes selecting the content server with the lowest latency and transmitting the data from the selected content server to the client system through the acceleration server.

Another embodiment is directed to a system for accelerating network traffic within a mesh network. The system includes a plurality of content servers configured to store and distribute data, a client system configured to make data requests, and an acceleration server. The acceleration server is coupled with the plurality of content servers and the client system. The acceleration server is configured to receiving a request for data from the client system, to determine in which of the plurality of content servers the requested data is stored, to determine latency between the acceleration server and the plurality of content servers in which the data is stored, and to select the content server with the lowest latency, to receive the data from the selected content server, and to transmit the received data to the client system.

In an alternative embodiment, a machine-readable medium is described. The machine-readable medium includes instructions for accelerating network traffic within a mesh network. The machine-readable medium includes instructions for receiving a data request from a client system, determining a first set of latency values between each of a plurality of acceleration servers and the client system, and determining a second set of latency values between each of a plurality of content servers and each of the plurality of acceleration servers. The machine-readable medium further includes instructions for based on the first and second sets of latency values, selecting an acceleration server and content server combination with the lowest latency, creating an acceleration tunnel between the client system and the selected content server through the selected acceleration server, and transmitting the data to the client system using the created acceleration tunnel.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating a method of acceleration of a mesh network, according to embodiments of the present invention.

FIG. 2 is a block diagram illustrating a system for acceleration of a mesh network, according to one embodiment of the present invention.

FIG. 3 is a block diagram illustrating a system for acceleration of a mesh network, according to one embodiment of the present invention.

FIG. 4 is a flow diagram illustrating a method of acceleration of a mesh network, according to embodiments of the present invention.

FIG. 5 is a block diagram illustrating a system for acceleration of a mesh network, according to one embodiment of the present invention.

FIG. 6 is a generalized schematic diagram illustrating a computer system, in accordance with various embodiments of the invention.

FIG. 7 is a block diagram illustrating a networked system of computers, which can be used in accordance with various embodiments of the invention.

### DETAILED DESCRIPTION OF THE INVENTION

The ensuing description provides exemplary embodiment(s) only and is not intended to limit the scope, applicability or configuration of the disclosure. Rather, the ensuing description of the exemplary embodiment(s) will provide those skilled in the art with an enabling description for implementing an exemplary embodiment. It should be understood that various changes may be made in the function and arrangement of elements without departing from the spirit and scope as set forth in the appended claims.

Aspects of the disclosure relate to the use of “effective latency” to make dynamic routing decisions in distributed IP network applications. Aspects of this disclosure further relate to latency-based bypass of acceleration servers in conjunction with latency-based routing. For example, a mobile client in San Francisco may be attempting to access a file on a content server in London with acceleration servers located in Berlin and Seattle. Based on latency data between the mobile device, the content server, and the acceleration servers, a decision whether to bypass the acceleration servers is made and, if it is determined not to bypass, a routing decision is made based on latency data.

In one embodiment, latency for the purposes of the present invention may be defined as “effective latency.” In other words, a routing decision may be made based on more than simply the RTT of a connection. For example, even though the RTT of the connection between a client and a server A is lower than the RTT between the client to a server B, server B may nonetheless still have a lower “effective latency.” Some reasons that server B may have a lower “effective latency” than server A is that server B has a cached version of the file that the client is requesting, server A may be overly congested at the time the client is requesting the file, the route from the client to server A may have connection failures, etc. Additional factors that can affect the “effective latency” are compression (e.g., compression size of packets and time required to perform compression), the bandwidth between various nodes, the amount of packet loss between various nodes, congestion (e.g., over-capacity at any node or at any group of nodes, etc.).

In addition, the chattiness of the application used to transfer data can affect the “effective latency.” For example, if downloading a single file over HTTP, there will be only one round trip so there may not be a significant benefit to going through an acceleration server. However, if downloading is done over CIFS/SMB (i.e., a file share protocol), which is very chatty (i.e., requires a significant amount of communication between a client and a server), there will typically be a greater benefit of using an accelerating proxy which is close to the content server. Hence, basing routing on “effective latency” will route the client to the server which will transmit the file to the client in the least amount of time.

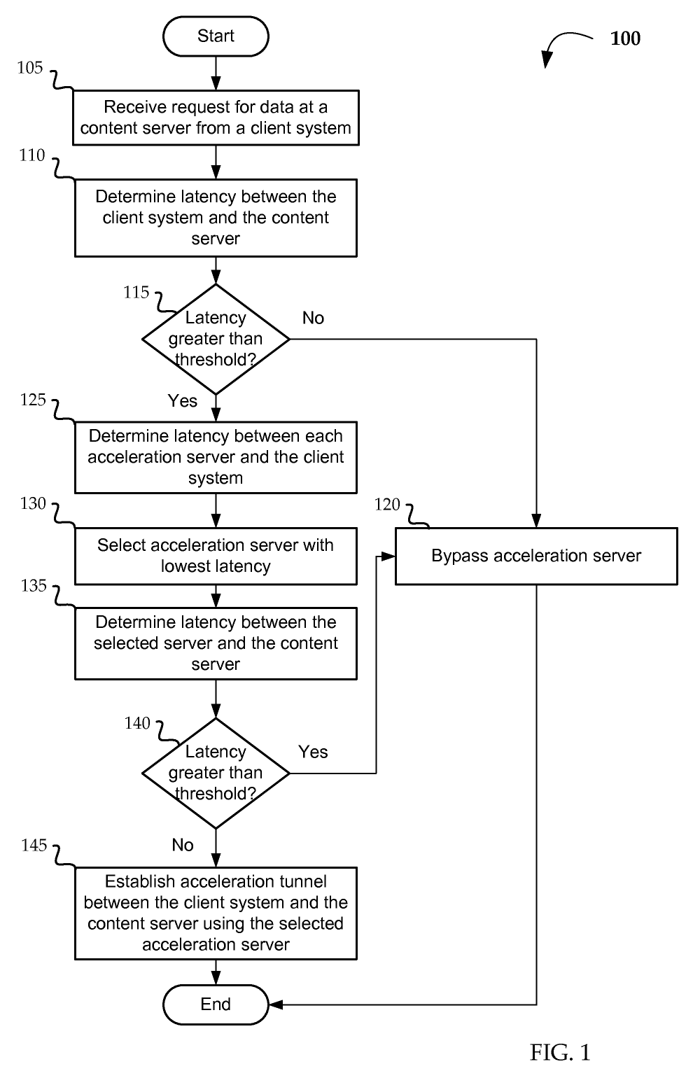

Turning now to FIG. 1 which illustrates a method 100 for performing latency-based bypass and routing according to aspects of the present invention. At process block 105, a request for data stored at a content server is made by a client system. In one embodiment, the content server is a file server, a web server, and FTP server, etc., and the client system is a mobile device (e.g., a cellular device, a laptop computer, a notebook computer, a personal digital assistant (PDA), a Smartphone, etc.), a personal computer, a desktop computer, etc. In one embodiment, the data requested may be a document (e.g., a text document, a word document, etc.), an image, web content, database content, etc.

At process block 110, the latency between the client system and the content server may be determined. This determination may be based in part on a round trip time (RTT) calculation between the client system and the content server. However, other latency calculation techniques may be used to determine the latency between the client system and the content server.

At decision block 115, the determined latency between the client system and the content server may be compared to a latency threshold (e.g., 30 milliseconds) to determine if the latency is greater than the threshold. In one embodiment, the threshold may be determined by analyzing historic latency data. In another embodiment, the threshold may be based on the network type, the network topology, the connection types, etc. If the latency between the client system and the content server is not greater than the threshold value, it is determined that responding to the data request from the client system by the content server would not benefit from acceleration through an acceleration server. In other words, because the latency is low enough between the client system and the content server, the additional overhead and/or distance required to utilize an acceleration server would not outweigh its benefit in this particular situation. Accordingly, the acceleration server is bypassed and the requested data is retrieved by the client system directly from the content server (process block 120).

However, if it is determined that the latency between the content server and the client system is greater than the threshold value, then a determination of the latency determination between the client system and each acceleration server may be determined (process block 125). In an alternative embodiment, in addition to making a latency determination, congestion of the acceleration server may also be a factor.

At process block 130, based on the latency determinations made with respect to each of the acceleration servers and the client system, the acceleration server with the lowest latency may be selected. A number of factors may contribute to variations in latency from one acceleration server to another. For example, the physical distance between the client system and the acceleration server may be a factor, the congestion of the acceleration server (i.e., how many other clients are attempting to utilize the acceleration server), the hardware and/or software of the acceleration server, bandwidth constraints, etc. Nonetheless, the acceleration server with the lowest latency with respect to the client system is selected.

At process block 135, the latency between the selected acceleration server and the content server may be determined. This determination can be made using the same or similar techniques as those used to determine latencies above. One technique used to determine latency may be to issue a TCP connect request to the server (i.e., the content server, acceleration server, etc.). Once the server responds to the TCP connect request, the RTT can be determined based on the amount of time the server takes to respond. In addition, this technique may indicate whether the server is accepting connections. At decision block 140, a determination may be made whether the latency between the selected acceleration server and the content server is greater than a threshold value. In one embodiment, the threshold value is the same as the threshold value used above; however, other threshold values may be used.

If it is determined that the latency between the selected acceleration server and the content server is greater than the threshold value, then the acceleration server will nonetheless be bypassed (process block 120). In other words, even though initially the acceleration server was not going to be bypassed (based on the initial latency determination between the client system and the acceleration server at process block 1 10), because the latency between the selected acceleration server and the content server is determined to be to high, the benefits of acceleration would nonetheless be out weighted by the high latency between the selected acceleration server and the content server.

On the other hand, if it is determined that the latency between the selected acceleration server and the content server is not greater than the threshold value, then the acceleration server is not bypassed. Instead, at process block 145, an acceleration tunnel may be established between the client system and the content server by way of the acceleration server. In one embodiment, the acceleration tunnel (or acceleration link) may be established using the techniques found in U.S. Provisional Application No. 60/980,101, entitled CACHE MODEL IN PREFETCHING SYSTEM, filed on Oct. 15, 2007, which is incorporated by reference in its entirety for any and all purposes.

In one embodiment, after the acceleration link has been established between the client system and the content server, the requested data may then be transmitted to the client system. Hence, the determination whether to bypass the acceleration server as well as the acceleration routing determination is based on latency (i.e., latency-based bypass and routing).

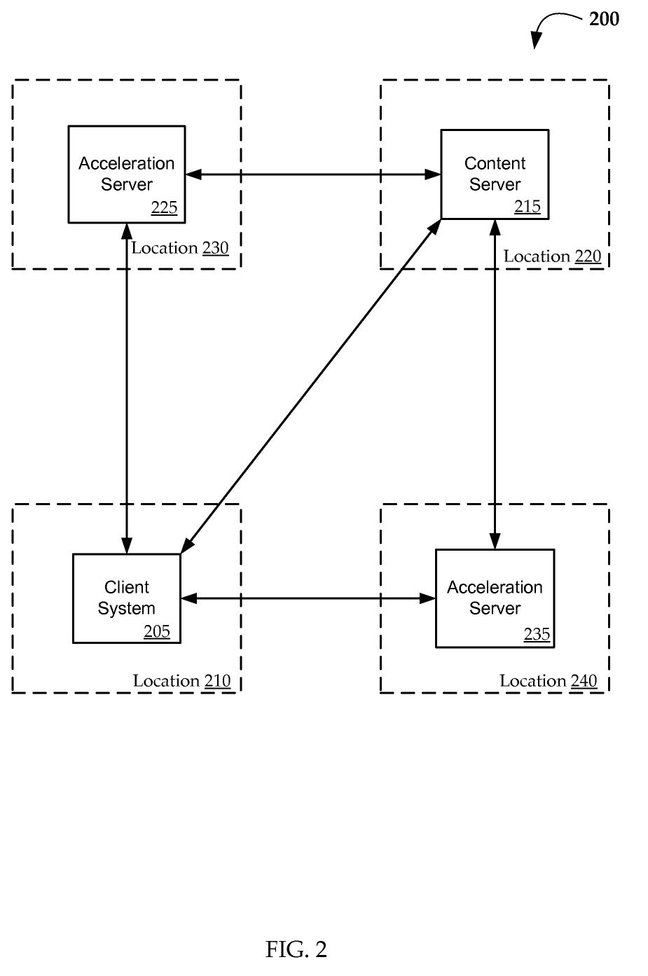

Referring now to FIG. 2 which illustrates one embodiment of a system 200 for performing latency-based bypass and routing according to aspects of the present invention. In one embodiment, system 200 may include a client system 205 at a location 210. Location 210 may be, for example, Denver, Colo. in which client system 205 is situated. In one embodiment, client system 205 may be a mobile client, a telecommuter, a system in a branch office, etc.

In a further embodiment, system 200 may include a content server 215 at a location 220. In one embodiment, content server 215 is a file server which is storing a file requested by client system 205. In a further embodiment, location 220 may be Tokyo, Japan. Furthermore, system 200 may include multiple acceleration servers (e.g., acceleration servers 225 and 235). Merely for the purpose of explanation and ease of understanding, FIG. 2 includes only two acceleration servers, but more than two acceleration servers may be included. In one embodiment, acceleration servers 225 and 235 are located at locations 230 and 240, respectively. In one embodiment, location 230 may be Seattle, Wash., and location 240 may be Beijing, China.

In one embodiment, client system 205 may connect to either acceleration servers 225 and 235 to reach content server 215, or client system 205 may connect directly to content server 215. In one embodiment, each of client system 205, content server 215, and acceleration servers 225 and 235 are located within local area networks (LANs), and together create a wide area network (WAN). Alternatively, content server 215 and acceleration servers 225 and 235 may be arranged in a hub-and-spoke network configuration. Furthermore, client system 205, content server 215, and acceleration server 225 and 235 may be connected over the Internet.

One example that may be illustrated by system 200 is client system 205 located in Denver, Colo. (location 210) needs to access a document located on content server 215 located in Tokyo, Japan (location 220). Client system 205 could access the document from content server 215 directly or client system 205 may want to accelerate its connection to content server 215 using acceleration servers 225 or 235. In order to determine the optimal route and whether to accelerate the connection or to bypass acceleration servers 225 or 235, latency determinations should be made.

In one embodiment, the latency between content server 215 and client system 205 is determined and checked against a latency threshold. Alternatively, the latency between client system 205 and acceleration servers 225 and 235 may also be determined in order to check which of the three have the lowest latency. If the latency between client system 205 and content server 215 is less than the threshold value or less than both of the latencies between client system 205 and acceleration servers 225 and 235, then acceleration servers 225 and 235 are bypassed and the document is directly accessed from content server 215.

Alternatively, if the latency between client system 205 and content server 215 is greater than the threshold, then the connection between client system 205 and either of acceleration servers 225 and 235 with the lower latency is selected. Specifically, it is determined which of acceleration servers 225 and 235 to use to accelerate the connection between client system 205 and content server 215.

Initially, it may seem that since acceleration server 225 is located in Seattle, Wash. (location 230) which is closer to client system 205 than acceleration server 235 located in Beijing, China (location 240), that it would be faster to use acceleration server 225. However, this may not be the case. For example, the initial connection from client system 205 to acceleration server 225 may be faster (i.e., Denver to Seattle) than the connection between client system 205 and acceleration server 235 (i.e., Denver to Beijing); however, it should be taken into consideration that the connection from acceleration server 225 to content server 215 (i.e., Seattle to Tokyo) is further than the connection between acceleration server 235 and content server 215 (Beijing to Tokyo).

Accordingly, the latency for each leg of the connection from client system 205 to contact server 215 is calculated in order for the total latency to be determined. Based on the latency calculations, it may be determined, for example, that the latency between client system 205 and content server 215 through acceleration server 235 is lower than the latency between client system 205 and content server 215 through acceleration server 225. Based on this determination, acceleration server 235 may be selected to accelerate the connection between content server 215 and client system 205.

Alternatively, it may be determined that even when accelerated through acceleration server 235, the direct connection between client system 205 and content server 215 still has a lower latency. Hence, acceleration server 235 may still be bypassed and client system 205 may access the document directly from content server 215. Ultimately, by basing bypass and routing on latency between the various connections, an optimal routing decision can be made.

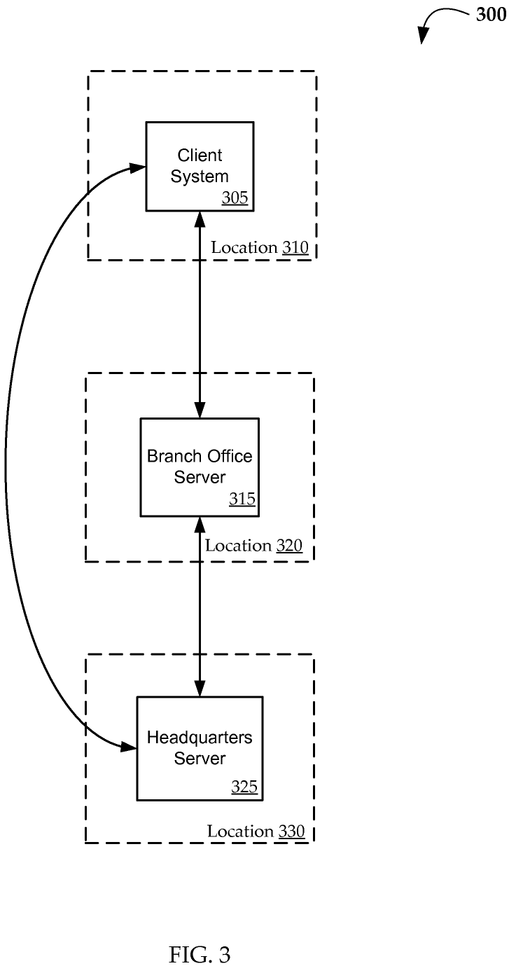

Turing now to FIG. 3, which illustrates a system 300 for performing hieratical latency-based bypass and routing according to aspects of the present invention. In one embodiment, a client system 305 may request a file from a headquarters server 325. Client system 305 may be able to directly access headquarters server 325, or client system 305 may be able to access headquarters server 325 through branch office server 315. Each of client system 305, branch office server 315, and headquarters server 325 may be located at different locations (i.e., locations 310, 320, and 330, respectively).

In one embodiment, latency values for the connections between client system 305 and branch office server 305, between branch office server 315 and headquarters server 325, and between client system 315 and headquarters server 325 may be determined. Based on these latency determinations it may be determined that, even though the connection between client system 305 and headquarters server 325 is a direct connection, the latency of that connection is greater than going through branch office server 315. Accordingly, the file request and file would be routed through branch office server 315. Alternatively, the requested file may be retrieved from branch office server 315 because the requested file includes a cached version of the request file.

Accordingly, as shown in the above example simply basing routing decisions on RTT would not transmit the file to client system 305 in the least amount of time. In other words, the RTT between client system 305 and headquarters server 325 may be less than the RTT between branch office server 315 and client system 305, but because the routing is based on “effective latency” instead of latency, the cached file on branch office server 315 is taken into consideration, and client 305 receives the file in less time. Hence, routing decisions based on “effective latency” provides for additional acceleration of file and other data transfers.

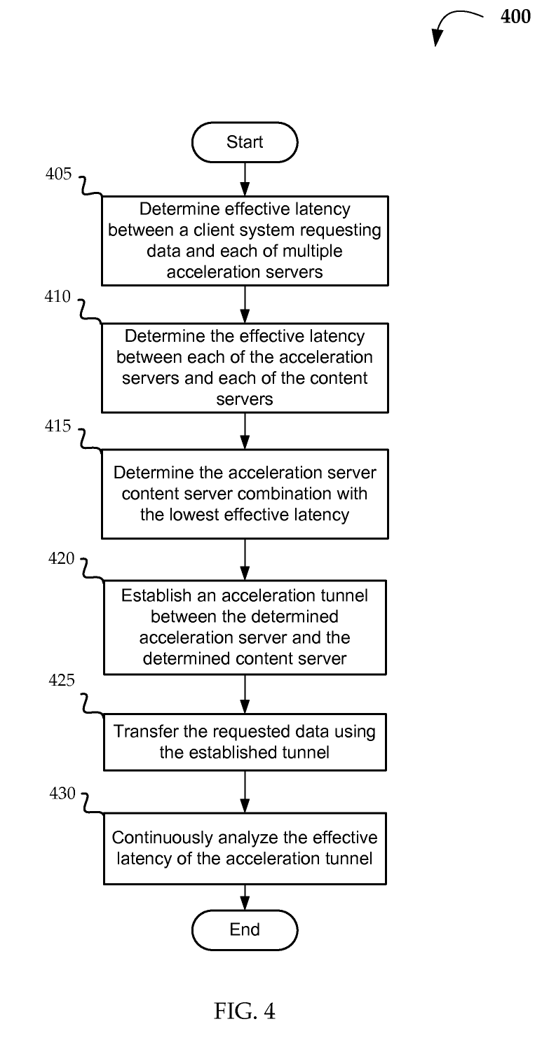

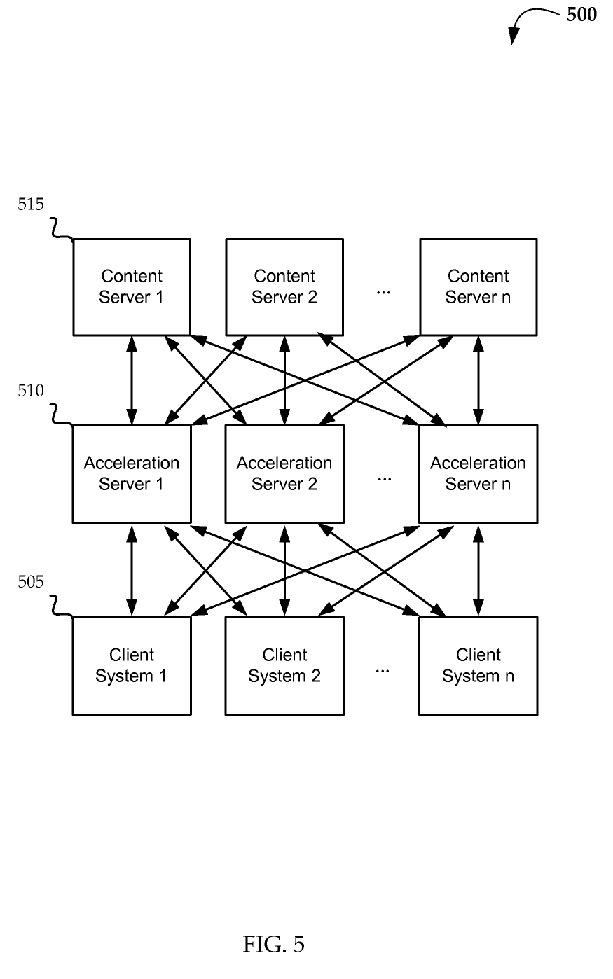

Turning now to FIG. 4, which illustrates a method 400 for accelerating network traffic within a mesh network 500 (FIG. 5). At process block 405, a determination of the effective latency between a client system and each of multiple acceleration servers included within a mesh network 500 (FIG. 5) is made. Furthermore, the effective latency between each of the acceleration servers may also be determined. In one embodiment, the client system is a mobile device, a cellular device, a satellite device, a personal computer, etc.; and the acceleration servers are computer systems (e.g., personal computers, servers, mobile computers, etc.) which are configured to accelerate network traffic between the client system and content servers. The content servers may be any one of a web server, a file server, a file transfer protocol (FTP) server, a database server, a mail server, etc. Furthermore, the content servers may be any TCP based content server.

As discussed above, the “effective latency” encompasses more than latency because the effective latency takes into account additional factors and/or conditions of the network connection. For example, congestion, connection quality, distance, RTT, bandwidth constraints, caching, pre-fetch information, etc. may be considered in determining the effective latency of a network connection. In other words, the effective latency determines more than simply what connection should provide the fastest transfers, but instead the effective latency determines which connection actually will have the fastest transfers.

At process block 410, the effective latency between each of the acceleration servers and the contents servers within the mesh network 500 (FIG. 5) may be determined. Furthermore, the effective latency between each of the content servers may be determined. Prior to this determination, a determination may be made as to which of the content servers contain the content being requested by the client system. Accordingly, only the effective latency between the acceleration servers 225 and 235 (FIG. 2) and content servers which contain the requested content would be determined.

Accordingly, the effective latencies between the client system and each of the acceleration servers, and the effective latency between each of the acceleration servers and each of the content servers within the mesh network 500 (FIG. 5) have been determined. Based on that information, a determination is made as to which acceleration server(s) and content server(s) combination has the best effective latency (process block 415). In other words, a determination is made as to which acceleration server-content server pairing/combination would produce the fastest transfer rate for the content which the client system is requesting. Alternately, this may include any number of acceleration servers and/or content server(s). For example, the lowest effective latency between the client system and a content server may be through two acceleration servers, or alternatively the lowest effective latency may be through two content servers. Essentially, which acceleration servers or content servers are used, how many of each, or the locations of the servers is merely a consideration; ultimately the combination which will produce the fastest rate of transfer to the client system takes precedent. Consequently, the client system could be located in the western United States and, because the effective latency between the client system and an acceleration server in Japan affords the fastest transfers (i.e., has the best effective latency), the acceleration server in Japan would be used. This may be the case even though there is an acceleration server also located in the western United States.

Furthermore, even though, for example, there is a content server located in the eastern United States, a content server in Australia may be selected based on effective latency. Additional factors, as described above, may be factored into the effective latency determination. For example, even though an acceleration server may be equipped to provide the client system with a seemingly faster transfer than another acceleration server, because the other acceleration server already has a cached and/or pre-fetched version of the requested content, the other acceleration server may be used. As a result, the entire mesh network 500 (FIG. 5) can be utilized in order to provide the client system with the most efficient and fastest transfer speeds.

In a further embodiment, a table (or other storage mechanism) may be maintained to store the effective latencies between each of the acceleration servers and content servers within the mesh network 500 (FIG. 5). Such a table may be continuously updated to reflect the most up-to-date changes in the various effective latency values. The table may further be configured to be able to insert any client system and its content request, and output the server combination with the fastest rate of transfer. Such a table may be dynamically updated and maintained to produce an accurate matrix of the servers included within the mesh network 500 (FIG. 5).

Turing now to process block 420, in which an acceleration tunnel may be established between the determined acceleration server(s), the determined content server(s), and the client system. Such an acceleration tunnel would reflect the faster transfer rate for the requested content to the client system at the time of transfer. A day, week, month, etc. later, this acceleration tunnel may change to reflect changes in the effective latencies of the servers within the mesh network 500 (FIG. 5). Thus, the dynamic nature of the effective latency calculations are reflected in the creation of the acceleration tunnels; changes in effective latencies would change the acceleration tunnel.

Accordingly, at process block 425, the requested content is transferred to the client system using the established acceleration tunnel. Once the acceleration tunnel has been established and content is being transferred between the client system and the content server, the effective latency may be continuously analyzed to determine whether a change in the effective latency has occurred which would necessitate a change in the acceleration/content servers selected (process block 430). Thus, the acceleration tunnel may be changed in order to increase the transfer rate. In such a situation, setup and/or startup costs would need to be taken into consideration.

In an alternative embodiment, the table may include static routes which may be configured to allow the client system to make routing decisions based on static routes which are preconfigured by, for example, an administrator. Furthermore, the client system is able to make such routing decisions without being in-line or in-path with a gateway server, an acceleration server, or the like. In one embodiment, in-line or in-path means that, for example, a gateway server, acceleration server, etc. is placed between the client system and the destination of the client system's request. In other words, any traffic received by or sent from the client system must pass through the in-line server. However, according to embodiments of the present invention, such an in-line server is not needed.

For example, assuming that the client system has access to a content server in a data center in New York and a content server in a data center in Los Angeles, and assume also that each of the data centers include an acceleration server. If, for example, the client system is located in Chicago and needs to access a file from either the New York data center or the Los Angeles data center, the client can access the dynamic table to determine which acceleration sever to use in order to retrieve the file. This decision would be made by the client without requiring the client to first go through an in-line server. The client system has the freedom and flexibility to decide the route to take in order to retrieve the desired content in the most optimal way. As stated above, the decision may be based on a dynamic table which indicates the most optimal path the client system should take in order to retrieve the file; however, a static table would also work in this situation. While the dynamic table does not provide configuration by an administrator, the static table allows for acceleration within a mesh network without the acceleration servers being required to be in-line.

Such a static table may simply indicate that if the file (or content) being accessed is in New York, then route accelerate the traffic through the New York acceleration server, and if the content is in Los Angeles then route the traffic through the Los Angeles acceleration server. Hence, the client system is able to retrieve the desired content, make the decision as to where to retrieve the content at the TCP level, and does not need an in-line server in order to make such decisions. Stated differently, the client system is able to determine the most optimal route to take in order to fulfill any requests.

Referring now to FIG. 5, which illustrates a mesh network 500 for implementing embodiments of the present invention. In one embodiment, mesh network 500 may include client systems 505, acceleration servers 510, and content servers 515. Each of client systems 505 may be connected to each of acceleration servers 5 10. The connections may be, for example, satellite connections, wireless connections, WiFi connections, DSL connections, cable connections, etc. Furthermore, each of client systems 505 may include a proxy client running on the system which is configured to communicate with acceleration servers 510 on behalf of client systems 505.

Furthermore, each of acceleration servers 510 may be connected with each of content servers 515 using various connection types. In one embodiment, client system 2 may request content (e.g., an email message, a text file, a JPEG file, a GIF file, an XML file, etc.). Upon making the request, a determination may be made to determine the effective latency between client system 2 and each of acceleration servers 510. In addition, a determination may be made as to which of content servers 515 have the requested content.

Subsequently, the effective latencies between each of acceleration servers 510 and each of content servers 515 (which contain the requested content) may be determined. Based on the effective latencies, a determination is made as to which acceleration server-content server combination provides client system 2 with the fastest transfer rate. For example, it may be determined that the effective latency between client system 2 and acceleration server 1 is lowest; however, the latency between acceleration server 1 and each of content servers 515 may be much higher than the effective latency between acceleration server 2 and each of content servers 515. Accordingly, even though the effective latency between client system 2 and acceleration server 1 is the lowest, that effective latency would be outweighed by acceleration server 1's high effective latency with content servers 515. Hence, acceleration server 2 would be selected along with content server 515 with the lowest effective latency with acceleration server 2. Thus, the highest transfer rate for client system 2 of the requested content is achieved.

Additionally, each of client systems 505, acceleration servers 510, and content servers 515 may be at various locations worldwide and may be various computer implementations. For example, acceleration server 2 may be located in Europe in a mainframe computer, whereas acceleration server 1 is located in Texas on a blade server. Furthermore, content server 1 may be located in Japan and be an FTP server, whereas content server 2 may be located in Canada and be a mail server. Similarly, client system 1 may be located in China and be a satellite-based device, whereas client system 2 may be located in South America and be a cellular device. Ultimately, the locations and device types of each of client systems 505, acceleration servers 510, and content servers 515 may be of less importance, and the effective latency and achieving the faster rate of transfer for client systems 505 is of the utmost importance.

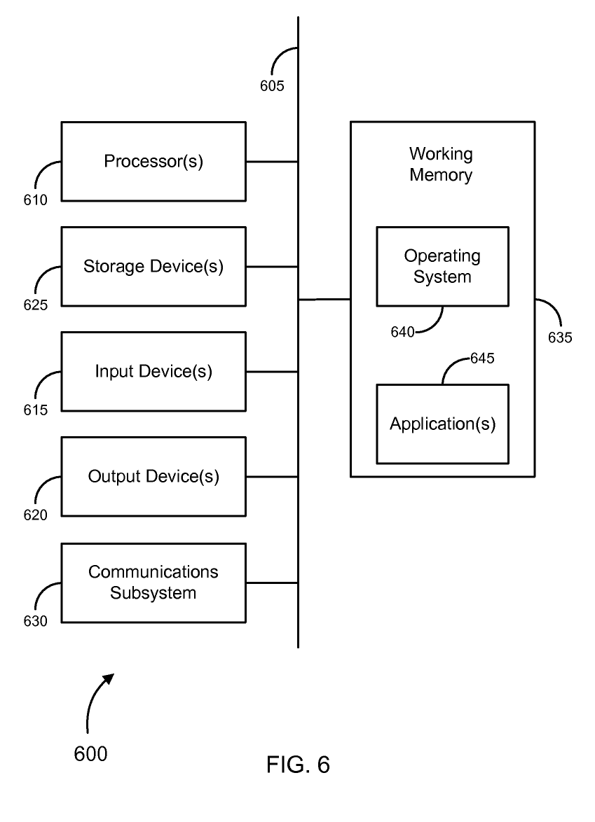

FIG. 6 provides a schematic illustration of one embodiment of a computer system 600 that can perform the methods of the invention, as described herein, and/or can function, for example, as any part of client system 205, acceleration server 225, content server 215, etc. of FIG. 2. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computer system 600 may further include (and/or be in communication with) one or more storage devices 625, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 600 might also include a communications subsystem 630, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), and/or any other devices described herein. In many embodiments, the computer system 600 will further comprise a working memory 635, which can include a RAM or ROM device, as described above.

The computer system 600 also can comprise software elements, shown as being currently located within the working memory 635, including an operating system 640 and/or other code, such as one or more application programs 645, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 600) to perform methods of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another machine-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various machine-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 625. Volatile media includes, without limitation dynamic memory, such as the working memory 635. Transmission media includes coaxial cables, copper wire and fiber optics, including the wires that comprise the bus 605, as well as the various components of the communication subsystem 630 (and/or the media by which the communications subsystem 630 provides communication with other devices). Hence, transmission media can also take the form of waves (including without limitation, radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc., carried by the signals) to the working memory 635, from which the processor(s) 605 retrieves and executes the instructions. The instructions received by the working memory 635 may optionally be stored on a storage device 625 either before or after execution by the processor(s) 610.

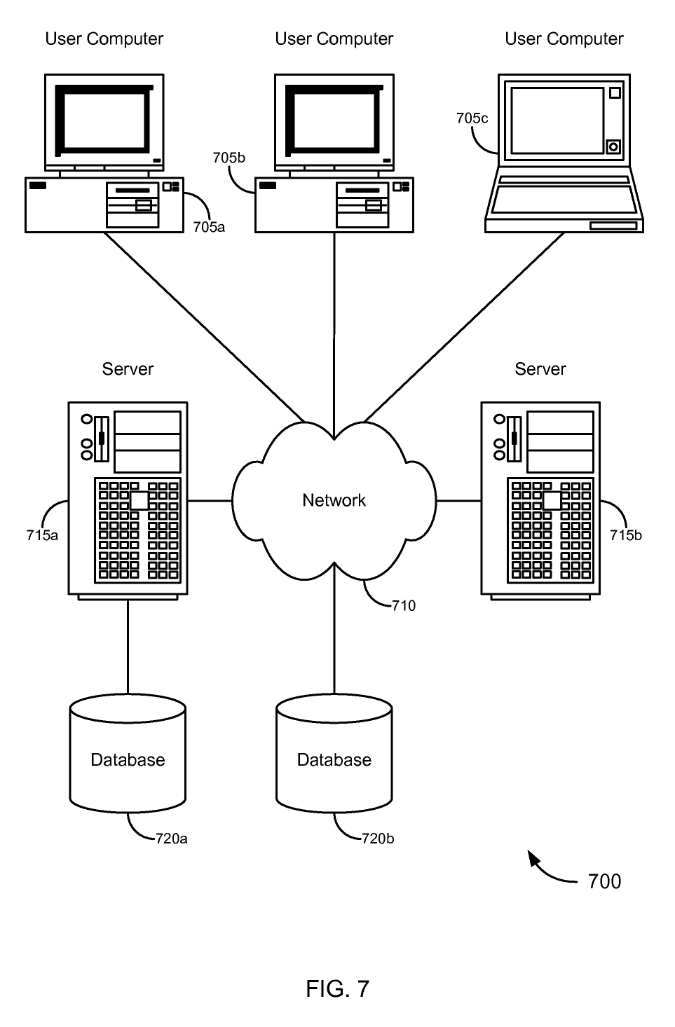

A set of embodiments comprises systems for dynamic routing. In one embodiment, client system 205, acceleration server 225, content server 215, etc. of FIG. 2, may be implemented as computer system 600 in FIG. 6. Merely by way of example, FIG. 7 illustrates a schematic diagram of a system 700 that can be used in accordance with one set of embodiments. The system 700 can include one or more user computers 705. The user computers 705 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 705 can also have any of a variety of applications, including one or more applications configured to perform methods of the invention, as well as one or more office applications, database client and/or server applications, and web browser applications. Alternatively, the user computers 705 can be any other electronic device, such as a thin-client computer, Internet-enabled mobile telephone, and/or personal digital assistant (PDA), capable of communicating via a network (e.g., the network 710 described below) and/or displaying and navigating web pages or other types of electronic documents. Although the exemplary system 700 is shown with three user computers 705, any number of user computers can be supported.

Certain embodiments of the invention operate in a networked environment, which can include a network 710. The network 710 can be any type of network familiar to those skilled in the art that can support data communications using any of a variety of commercially available protocols, including without limitation TCP/IP, SNA, IPX, AppleTalk, and the like. Merely by way of example, the network 710 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 715. Each of the server computers 715 may be configured with an operating system, including without limitation any of those discussed above, as well as any commercially (or freely) available server operating systems. Each of the servers 715 may also be running one or more applications, which can be configured to provide services to one or more clients 705 and/or other servers 715.

Merely by way of example, one of the servers 715 may be a web server, which can be used, merely by way of example, to process requests for web pages or other electronic documents from user computers 705. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 705 to perform methods of the invention.

The server computers 715, in some embodiments, might include one or more application servers, which can include one or more applications accessible by a client running on one or more of the client computers 705 and/or other servers 715. Merely by way of example, the server(s) 715 can be one or more general purpose computers capable of executing programs or scripts in response to the user computers 705 and/or other servers 715, including without limitation web applications (which might, in some cases, be configured to perform methods of the invention). Merely by way of example, a web application can be implemented as one or more scripts or programs written in any suitable programming language, such as Java , C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 705 and/or another server 715. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer 705 via a web server (as described above, for example). Similarly, a web server might receive web page requests and/or input data from a user computer 705 and/or forward the web page requests and/or input data to an application server. In some cases a web server may be integrated with an application server.

In accordance with further embodiments, one or more servers 715 can function as a file server and/or can include one or more of the files (e.g., application code, data files, etc.) necessary to implement methods of the invention incorporated by an application running on a user computer 705 and/or another server 715. Alternatively, as those skilled in the art will appreciate, a file server can include all necessary files, allowing such an application to be invoked remotely by a user computer 705 and/or server 715. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 720. The location of the database(s) 720 is discretionary: merely by way of example, a database 720a might reside on a storage medium local to (and/or resident in) a server 715a (and/or a user computer 705). Alternatively, a database 720b can be remote from any or all of the computers 705, 715, so long as the database can be in communication (e.g., via the network 710) with one or more of these. In a particular set of embodiments, a database 720 can reside in a storage-area network (“SAN”) familiar to those skilled in the art. (Likewise, any necessary files for performing the functions attributed to the computers 705, 715 can be stored locally on the respective computer and/or remotely, as appropriate.) In one set of embodiments, the database 720 can be a relational database that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of accelerating network traffic within a mesh network, the method comprising:
receiving a data request from a client system;
determining a first set of latency values between each of a plurality of acceleration servers and the client system;
determining a second set of latency values between each of a plurality of content servers and each of the plurality of acceleration servers;
based on the first and second sets of latency values, selecting an acceleration server and content server combination with the lowest latency;
creating an acceleration tunnel between the client system and the selected content server through the selected acceleration server; and
transmitting the data to the client system using the created acceleration tunnel.

2. A method of accelerating network traffic within a mesh network as in claim 1, further comprising:
determining that the combination of the first and second latency values exceed a threshold value;
in response to the combination of the first and second latency values exceeding the threshold value, bypassing the plurality of acceleration servers; and
transmitting the requested data to the client system directly from one of the plurality of content servers.

3. A method of accelerating network traffic within a mesh network as in claim 1, further comprising:
determining that the second latency value exceeds a threshold value;
in response to the second latency value exceeding the threshold value, bypassing the plurality of acceleration servers; and
transmitting the requested data to the client system directly from one of the plurality of content servers.

4. A method of accelerating network traffic within a mesh network as in claim 1, wherein the latency is effective latency.

5. A method of accelerating network traffic within a mesh network as in claim 4, wherein effective latency is a measurement of latency based on one or more of: round trip times (RTT), caching, prefetching, acceleration, and bandwidth load.

6. A method of accelerating network traffic within a mesh network, the method comprising:
receiving, at an acceleration server from a client system, a request for data;
determining which of a plurality of content servers the data is stored, wherein the acceleration server, the client system, and the plurality of content servers are configured in a mesh network;
determining latency between the acceleration server and the plurality of content servers in which the data is stored;
selecting the content server with the lowest latency; and
transmitting the data from the selected content server to the client system through the acceleration server.

7. A method of accelerating network traffic within a mesh network as in claim 6, further comprising:
determining a latency between the client system and the acceleration server;
determining a latency between the selected content server and the client system;
based on the latency between the client system and the acceleration server being greater than the latency between the client system and the selected content server, bypassing the acceleration server; and
transmitting the data from the selected content server directly to the client system.

8. A method of accelerating network traffic within a mesh network as in claim 6, wherein the client system, the plurality of content servers and the acceleration server are each located in a different geographic location.

9. A method of accelerating network traffic within a mesh network as in claim 6, wherein the plurality of acceleration servers are configured to optimize network communication between the client system and the selected content server.

10. A method of accelerating network traffic within a mesh network as in claim 6, wherein the content server is one or more of the following: a file server, a file transfer protocol (FTP) server, and a web server, and any other TCP-based application server.

11. A method of accelerating network traffic within a mesh network as in claim 6, wherein the client system is one or more of the following: a mobile device, a cellular device, a personal computer, and a portable computer.

12. A method of accelerating network traffic within a mesh network as in claim 6, wherein the latency is based at least in part on one or more of the following: round trip time (RTT), congestion, bandwidth capabilities, and packet loss rates.

13. A method of accelerating network traffic within a mesh network as in claim 6, wherein the acceleration server is configured to implement acceleration techniques on traffic sent between the acceleration server and the client system.

14. A method of accelerating network traffic within a mesh network as in claim 6, wherein the latency is effective latency.

15. A method of accelerating network traffic within a mesh network as in claim 14, wherein effective latency comprises aggregating a plurality of factors when determining latency.

16. A system for accelerating network traffic within a mesh network, the system comprising:
a plurality of content servers configured to store and distribute data;
a client system configured to make data requests; and
an acceleration server coupled with the plurality of content servers and the client system, the acceleration server configured to receiving a request for data from the client system, to determine in which of the plurality of content servers the requested data is stored, to determine latency between the acceleration server and the plurality of content servers in which the data is stored, and to select the content server with the lowest latency, to receive the data from the selected content server, and to transmit the received data to the client system.

17. A system for accelerating network traffic within a mesh network as in claim 16, wherein the acceleration server is further configured to determine a latency between the client system and the acceleration server, and determine a latency between the selected content server and the client system.

18. A system for accelerating network traffic within a mesh network as in claim 17, wherein the acceleration server is further configured to, based on the latency between the client system and the acceleration server being greater than the latency between the client system and the selected content server, bypass the acceleration server, and transmit the data from the selected content server directly to the client system

19. A system for accelerating network traffic within a mesh network as in claim 16, wherein the latency is effective latency.

20. A machine-readable medium having sets of instructions stored thereon which, when executed by a machine, cause the machine to:
receive a data request from a client system;
determine a first set of latency values between each of a plurality of acceleration servers and the client system;
determine a second set of latency values between each of a plurality of content servers and each of the plurality of acceleration servers;
based on the first and second sets of latency values, select an acceleration server and content server combination with the lowest latency;
create an acceleration tunnel between the client system and the selected content server through the selected acceleration server; and
transmit the data to the client system using the created acceleration tunnel.
